(19) United States
(12) Patent Application Publication
(10) Pub. No.: US 2025/0088933 A1
(43) Pub. Date: Mar. 13, 2025

(54) RACH-LESS CONDITIONAL HANDOVER

(71) Applicant: Samsung Electronics Co., Ltd., Suwon-si (KR)

(72) Inventors: Shiyang Leng, Allen, TX (US); Kyeongin Jeong, Allen, TX (US); Anil Agiwal, McKinney, TX (US); Ravindranath Kanamangala, Plano, TX (US)

(21) Appl. No.: 18/818,511

(22) Filed: Aug. 28, 2024

Related U.S. Application Data
(60) Provisional application No. 63/538,005, filed on Sep. 12, 2023.
(60) Provisional application No. 63/538,917, filed on Sep. 18, 2023.

(51) Int. Cl. H04W 36/36; H04W 36/00

(52) U.S. Cl. CPC H04W 36/362; H04W 36/0061; H04W 36/00725

(57) ABSTRACT

A random access channel (RACH)-less conditional cell switch is provided. A user equipment (UE) receives and stores a candidate cell configuration including an execution condition of a conditional cell switch to the candidate cell. The UE selects the candidate cell as a target cell for the conditional cell switch on determination that the execution condition is met. The UE determines whether a valid timing advance (TA) and a valid uplink (UL) grant for initial UL transmission to the target cell is available. When a valid TA and a valid UL grant are available, UE transmits initial UL transmission to the target cell using the valid TA and the valid UL grant. When a valid TA is unavailable, the UE performs random access procedure to the target cell. When a valid UL grant is unavailable, the UE transmits a scheduling request to the target cell.

### CROSS-REFERENCE TO RELATED APPLICATIONS

This application claims the benefit of priority from U.S. Provisional Application No. 63/538,005 entitled “RACH-LESS HANDOVER IN CONDITIONAL MOBILITY,” filed Sep. 12, 2023; and U.S. Provisional Application No. 63/538,917 entitled “RACH-LESS HANDOVER IN CONDITIONAL MOBILITY,” filed Sep. 18, 2023, all which are incorporated herein by reference in their entirety.

### TECHNICAL FIELD

This disclosure relates generally to a wireless communication system, and more particularly to, for example, but not limited to, mobility in a wireless communication system.

### BACKGROUND

Mobility management operations including network handovers represent a pivotal aspect of any wireless communication system. These systems include, for example, LTE and 5G New Radio (NR), and upcoming technologies currently coined “6G”. Mobility is presently controlled by the network with user equipment (UE) assistance to maintain optimal connection quality. The network may hand over the UE to a target cell with superior signal quality.

The inclusion of enhanced broadband mechanisms requiring high speeds and low latencies has necessitated more sophisticated handover mechanisms. Accordingly, conditional handovers (CHOs) and separately, layer 1/layer 2 triggered mobility (LTM) have been introduced to provide additional conditions for specific networks or slices thereof to increase handover speed. The use of these enhancements, however, introduces latencies of its own, at least because the network needs to conduct several data exchanges with the UE during the handover process. The initiation of a prospective handover triggered by the network consequently introduces latencies, signaling overhead, and interruption times of its own.

The description set forth in the background section should not be assumed to be prior art merely because it is set forth in the background section. The background section may describe aspects or embodiments of the present disclosure.

### SUMMARY

An aspect of the disclosure provides a user equipment (UE) for facilitating communication in a wireless network. The UE comprises a transceiver configured to receive, from a source cell, a conditional cell switch configuration including one or more execution conditions for one or more candidate cells, wherein each execution condition of the one or more execution conditions is associated with a conditional cell switch to a corresponding candidate cell. The UE comprises a processor operably coupled to the transceiver, the processor configured to determine whether the one or more execution conditions are met, select a candidate cell as a target cell for a conditional cell switch based on a determination that an execution condition of the candidate cell is met, and determine whether a valid timing advance (TA) and a valid uplink (UL) grant for initial UL transmission to the target cell are available. The transceiver is further configured to transmit, to the target cell, initial UL transmission using the valid TA and the valid UL grant based on a determination that the valid TA and the valid UL grant are available.

In some embodiments, the transceiver is further configured to perform random access procedure to the target cell based on a determination that the valid TA is unavailable.

In some embodiments, the transceiver is further configured to transmit, to the target cell, a scheduling request based on a determination that the valid UL grant is unavailable.

In some embodiments, the conditional cell switch configuration includes at least one of a TA information or a configured UL grant for the initial UL transmission to the target cell.

In some embodiments, the processor is configured to determine that the TA information is valid based on a determination that a time condition or a distance condition included in the conditional cell switch configuration is met.

In some embodiments, the processor is configured to determine that the configured UL grant is valid based on a determination that a time condition included in the conditional cell switch configuration is met.

In some embodiments, the processor is configured to determine that a pair of the TA information and the configured UL grant is valid based on a determination that a time condition associated with the pair of the TA information and the UL grant is met.

In some embodiments, the conditional cell switch configuration includes one or more configured UL grants for each candidate cell, each configured UL grant of the one or more configured UL grant being associated with a respective one of one or more beams.

In some embodiments, the processor is further configured to select a beam among the one or more beams based on the execution condition of the candidate cell, and determine that a configured UL grant associated with the selected beam is valid.

In some embodiments, the processor is further configured to perform TA estimation for the target cell based on a UE location, satellite ephemeris and common TA information, and determine that the estimated TA is valid based on the satellite ephemeris and the common TA information provided in the conditional cell switch configuration being valid.

Another aspect of the disclosure provides a method performed by a user equipment (UE) in a wireless network. The method comprises receiving, from a source cell, a conditional cell switch configuration including one or more execution conditions for one or more candidate cells, wherein each execution condition of the one or more execution conditions is associated with a conditional cell switch to a corresponding candidate cell, determining whether the one or more execution conditions are met, selecting a candidate cell as a target cell for a conditional cell switch based on a determination that an execution condition of the candidate cell is met, determining whether a valid timing advance (TA) and a valid uplink (UL) grant for initial UL transmission to the target cell are available, and transmitting, to the target cell, initial UL transmission using the valid TA and the valid UL grant based on a determination that the valid TA and the valid UL grant are available.

In some embodiments, the method further comprises performing random access procedure to the target cell based on a determination that the valid TA is unavailable.

In some embodiments, the method further comprises transmitting, to the target cell, a scheduling request based on a determination that the valid UL grant is unavailable.

In some embodiments, the conditional cell switch configuration includes at least one of a TA information or a configured UL grant for the initial UL transmission to the target cell.

In some embodiments, the determining whether the valid TA and the valid UL grant are available comprises determining that the TA information is valid based on a determination that a time condition or a distance condition included in the conditional cell switch configuration is met.

In some embodiments, the determining whether the valid TA and the valid UL grant are available comprises determining that the configured UL grant is valid based on a determination that a time condition included in the conditional cell switch configuration is met.

In some embodiments, the determining whether the valid TA and the valid UL grant are available comprises determining that a pair of the TA information and the configured UL grant is valid based on a determination that a time condition associated with the pair of the TA information and the UL grant is met.

In some embodiments, the conditional cell switch configuration includes one or more configured UL grants for each candidate cell, each configured UL grant of the one or more configured UL grants being associated with a respective one of one or more beams

In some embodiments, the method further comprises selecting a beam among the one or more beams based on the execution condition of the candidate cell, and determining that a configured UL grant associated with the selected beams is valid.

In some embodiments, the method further comprises performing TA estimation for the target cell based on a UE location, satellite ephemeris and common TA information, and determining that the estimated TA is valid based on the satellite ephemeris and the common TA information provided in the conditional cell switch configuration being valid.

Another aspect of the disclosure provides a base station (BS) for facilitating communication in a wireless network. The BS comprises a transceiver configured to receive, from a user equipment (UE), a measurement report. The BS comprises a processor operably coupled to the transceiver, the processor configured to determine to prepare a conditional cell switch based on the measurement report, and generate a conditional cell switch configuration including one or more execution conditions for one or more candidate cells. Each execution condition of the one or more execution conditions is associated with a conditional cell switch to a corresponding candidate cell, and the transceiver is further configured to transmit the conditional configuration to the UE.

In some embodiments, the conditional cell switch configuration includes at least one of a timing advance (TA) information or a configured uplink (UL) grant for initial UL transmission to each candidate cell of the one or more candidate cells.

### BRIEF DESCRIPTION OF THE DRAWINGS

FIG. 1 shows an example of a wireless network in accordance with an embodiment.

FIG. 2A shows an example of a wireless transmit path in accordance with an embodiment.

FIG. 2B shows an example of a wireless receive path in accordance with an embodiment.

FIG. 3A shows an example of a user equipment (“UE”) in accordance with an embodiment.

FIG. 3B shows an example of a base station (“BS”) in accordance with an embodiment.

FIG. 4 shows an example process for RACH-less conditional cell switch in accordance with an embodiment.

FIG. 5 shows an example process for signaling RACH-less conditional cell switch

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in numerous ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied using a multitude of different approaches. The examples in this disclosure are based on the current 5G NR systems, 5G-Advanced (5G-A) and further improvements and advancements thereof and to the upcoming 6G communication systems. However, under various circumstances, the described embodiments may also be implemented in any device, system or network that is capable of transmitting and receiving radio frequency (RF) signals according to other technologies, such as the 3G and 4G systems, or further implementations thereof. For example, the principles of the disclosure may apply to Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), enhancements of 5G NR, AMPS, or other known signals that are used to communicate within a wireless, cellular or IoT network, such as one or more of the above-described systems utilizing 3G, 4G, 5G, 6G or further implementations thereof. The technology may also be relevant to and may apply to any of the existing or proposed IEEE 802.11 standards, the Bluetooth standard, and other wireless communication standards.

Wireless communications like the ones described above have been among the most commercially acceptable innovations in history. Setting aside the automated software, robotics, machine learning techniques, and other software that automatically use these types of communication devices, the sheer number of wireless or cellular subscribers continues to grow. A little over a year ago, the number of subscribers to the various types of communication services had exceeded five billion. That number has long since been surpassed and continues to grow quickly. The demand for services employing wireless data traffic is also rapidly increasing, in part due to the growing popularity among consumers and businesses of smart phones and other mobile data devices, such as tablets, “note pad” computers, net books, eBook readers, and dedicated machine-type devices. It should be self-evident that, to meet the high growth in mobile data traffic and support new applications and deployments, improvements in radio interface efficiency and coverage are of paramount importance.

To continue to accommodate the growing demand for the transmission of wireless data traffic having dramatically increased over the years, and to facilitate the growth and sophistication of so-called “vertical applications” (that is, code written or produced in accordance with a user's or entities' specific requirements to achieve objectives unique to that user or entity, including enterprise resource planning and customer relationship management software, for example), 5G communication systems have been developed and are currently being deployed commercially. 5G Advanced, as defined in 3GPP Release 18, is yet a further upgrade to aspects of 5G and has already been introduced as an optimization to 5G in certain countries. Development of 5G Advanced is well underway. The development and enhancements of 5G also can accord processing resources greater overall efficiency, including, by way of example, in high-intensive machine learning environments involving precision medical instruments, measurement devices, robotics, and the like. Due to 5G and its expected successor technologies, access to one or more application programming interfaces (APIs) and other software routines by these devices are expected to be more robust and to operate at faster speeds.

Among other advantages, 5G can be implemented to include higher frequency bands, including in particular 28 GHz or 60 GHz frequency bands. More generally, such frequency bands may include those above 6 GHz bands. A key benefit of these higher frequency bands are potentially significantly superior data rates. One drawback is the requirement in some cases of line-of-sight (LOS), the difficulty of higher frequencies to penetrate barriers between the base station and UE, and the shorter overall transmission range. 5G systems rely on more directed communications (e.g., using multiple antennas, massive multiple-input multiple-output (MIMO) implementations, transmit and/or receive beamforming, temporary power increases, and like measures) when transmitting at these mmWave (mmW) frequencies. In addition, 5G can beneficially be transmitted using lower frequency bands, such as below 6 GHz, to enable more robust and distant coverage and for mobility support (including handoffs and the like). As noted above, various aspects of the present disclosure may be applied to 5G deployments, to 6G systems currently under development, and to subsequent releases. The latter category may include those standards that apply to the THz frequency bands. To decrease propagation loss of the radio waves and increase transmission distance. as noted in part, emerging technologies like MIMO, Full Dimensional MIMO (FD-MIMO), array antenna, digital and analog beamforming, large scale antenna techniques and other technologies are discussed in the various 3GPP-based standards that define the implementation of 5G communication systems.

In addition, in 5G communication systems, development for system network improvement is underway or has been deployed based on advanced small cells, cloud Radio Access Networks (RANs), ultra-dense networks, device-to-device (D2D) communication, wireless backhaul, moving networks, cooperative communication, Coordinated Multi-Points (CoMP), reception-end interference cancellation, and the like. As exemplary technologies like neural-network machine learning, unmanned or partially-controlled electric vehicles, or hydrogen-based vehicles begin to emerge, these 5G advances are expected to play a potentially significant role in their respective implementations. Further advanced access technologies under the umbrella of 5G that have been developed or that are under development include, for example: advanced coding modulation (ACM) schemes using Hybrid frequency-shift-keying (FSK), frequency quadrature amplitude modulation (FQAM) and sliding window superposition coding (SWSC); and advanced access technologies using filter bank multi-carrier (FBMC), non-orthogonal multiple access (NOMA), and sparse code multiple access (SCMA).

Also under development are the principles of the 6G technology, which may roll out commercially at the end of decade or even earlier. 6G systems are expected to take most or all the improvements brought by 5G and improve them further, as well as to add new features and capabilities. It is also anticipated that 6G will tap into uncharted areas of bandwidth to increase overall capacities. As noted, principles of this disclosure are expected to apply with equal force to 6G systems, and beyond.

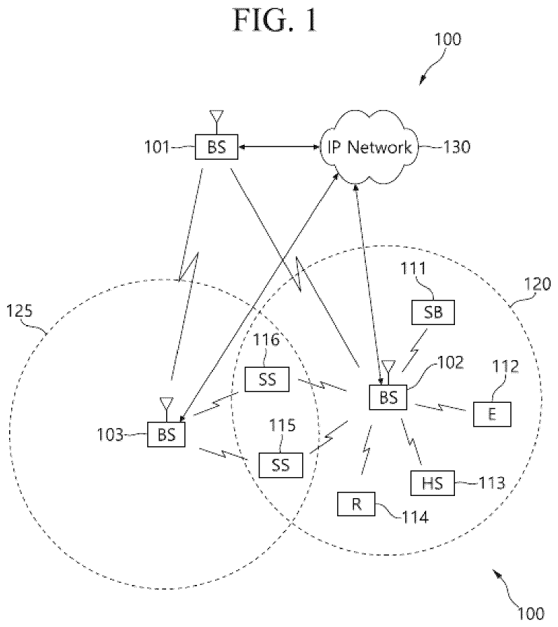

FIG. 1 shows an example of a wireless network 100 in accordance with an embodiment. The embodiment of the wireless network 100 shown in FIG. 1 is for purposes of illustration only. Other embodiments of the wireless network 100 can be used without departing from the scope of this disclosure. Initially it should be noted that the nomenclature may vary widely depending on the system. For example, in FIG. 1, the terminology “BS” (base station) may also be referred to as an eNodeB (eNB), a gNodeB (gNB), or at the time of commercial release of 6G, the BS may have another name. For the purposes of this disclosure, BS and gNB are used interchangeably. Thus, depending on the network type, the term ‘gNB’ can refer to any component (or collection of components) configured to provide remote terminals with wireless access to a network, such as base transceiver station, a radio base station, transmit point (TP), transmit-receive point (TRP), a ground gateway, an airborne gNB, a satellite system, mobile base station, a macrocell, a femtocell, a WiFi access point (AP) and the like. Referring back to FIG. 1, the network 100 includes BSs (or gNBs) 101, 102, and 103. BS 101 communicates with BS 102 and BS 103. BSs may be connected by way of a known backhaul connection, or another connection method, such as a wireless connection. BS 101 also communicates with at least one Internet Protocol (IP)-based network 130. Network 130 may include the Internet, a proprietary IP network, or another network.

Similarly, depending on the network 100 type, other well-known terms may be used instead of “user equipment” or “UE,” such as “mobile station,” “subscriber station,” “remote terminal,” “wireless terminal,” or “user device.” For the sake of convenience, the terms “user equipment” and “UE” are used interchangeably with “subscriber station” in this patent document to refer to remote wireless equipment that wirelessly accesses a gNB, whether the UE is a mobile device (such as a mobile telephone or smartphone) or is normally considered a stationary device (such as a desktop computer, vending machine, appliance, or any device with wireless connectivity compatible with network 100). With continued reference to FIG. 1, BS 102 provides wireless broadband access to the IP network 130 for a first plurality of user equipments (UEs) within a coverage area 120 of the BS 102. The first plurality of UEs includes a UE 111, which may be located in a small business (SB); a UE 112, which may be located in an enterprise (E); a UE 113, which may be located in a WiFi hotspot (HS); a UE 114, which may be located in a first residence (R); a UE 115, which may be located in a second residence (R); and a UE 116, which may be a mobile device (M) like a cell phone, a wireless laptop, a wireless PDA, or the like. The BS 103 provides wireless broadband access to IP network 130 for a second plurality of UEs within a coverage area 125 of the BS 103. The second plurality of UEs includes the UE 115 and the UE 116, which are in both coverage areas 120 and 125. In some embodiments, one or more of the BSs 101-103 may communicate with each other and with the UEs 111-116 using 6G, 5G, long-term evolution (LTE), LTE-A, WiMAX, or other advanced wireless communication techniques.

In FIG. 1, as noted, dotted lines show the approximate extents of the coverage area 120 and 125 of BSs 102 and 103, respectively, which are shown as approximately circular for the purposes of illustration and explanation. It should be clearly understood that coverage areas associated with APs, such as the coverage areas 120 and 125, may have other shapes, including irregular shapes, depending on the configuration of the BSs. Although FIG. 1 illustrates one example of a wireless network 100, various changes may be made to FIG. 1. For example, the wireless network 100 can include any number of BSs/gNBs and any number of UEs in any suitable arrangement. Also, the BS 101 can communicate directly with any number of UEs and provide those UEs with wireless broadband access to IP network 130. Similarly, each BS 102 or 103 can communicate directly with IP network 130 and provide UEs with direct wireless broadband access to the network 130. Further, gNB 101, 102, and/or 103 can provide access to other or additional external networks, such as external telephone networks or other types of data networks.

It will be appreciated that in 5G systems, the BS 101 may include multiple antennas, multiple radio frequency (RF) transceivers, transmit (TX) processing circuitry, and receive (RX) processing circuitry. The BS 101 also may include a controller/processor, a memory, and a backhaul or network interface. The RF transceivers may receive, from the antennas, incoming RF signals, such as signals transmitted by UEs in network 100. The RF transceivers may down-convert the incoming RF signals to generate intermediate (IF) or baseband signals. The IF or baseband signals are sent to the RX processing circuitry, which generates processed baseband signals by filtering, decoding, and/or digitizing the baseband or IF signals. The RX processing circuitry transmits the processed baseband signals to the controller/processor for further processing.

The controller/processor can include one or more processors or other processing devices that control the overall operation of the BS 101 (FIG. 1). For example, the controller/processor may control the reception of uplink signals and the transmission of downlink signals by the UEs, the RX processing circuitry, and the TX processing circuitry in accordance with well-known principles. The controller/processor may support additional functions as well, such as more advanced wireless communication functions. For instance, the controller/processor may support beamforming or directional routing operations in which outgoing signals from multiple antennas are weighted differently to effectively steer the outgoing signals in a desired direction. The controller/processor may also support OFDMA operations in which outgoing signals may be assigned to different subsets of subcarriers for different recipients (e.g., different UEs 111-114). Any of a wide variety of other functions may be supported in the BS 101 by the controller/processor including a combination of MIMO and OFDMA in the same transmit opportunity. In some embodiments, the controller/processor may include at least one microprocessor or microcontroller. The controller/processor is also capable of executing programs and other processes resident in the memory, such as an OS. The controller/processor can move data into or out of the memory as required by an executing process.

The controller/processor is also coupled to the backhaul or network interface. The backhaul or network interface allows the BS 101 to communicate with other BSs, devices or systems over a backhaul connection or over a network. The interface may support communications over any suitable wired or wireless connection(s). For example, the interface may allow the BS 101 to communicate over a wired or wireless local area network or over a wired or wireless connection to a larger network (such as the Internet). The interface may include any suitable structure supporting communications over a wired or wireless connection, such as an Ethernet or RF transceiver. The memory is coupled to the controller/processor. Part of the memory may include a RAM, and another part of the memory may include a Flash memory or other ROM.

For purposes of this disclosure, the processor may encompass not only the main processor, but also other hardware, firmware, middleware, or software implementations that may be responsible for performing the various functions. In addition, the processor's execution of code in a memory may include multiple processors and other elements and may include one or more physical memories. Thus, for example, the executable code or the data may be located in different physical memories, which embodiment remains within the spirit and scope of the present disclosure.

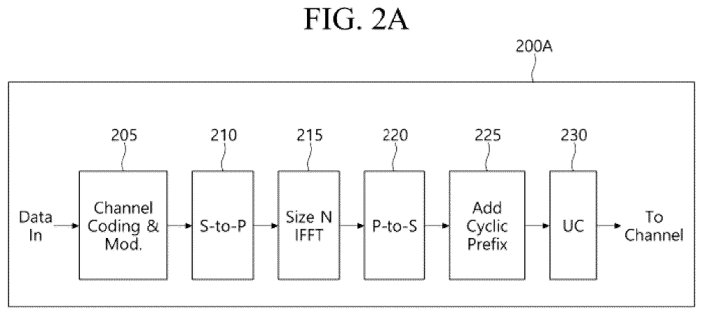

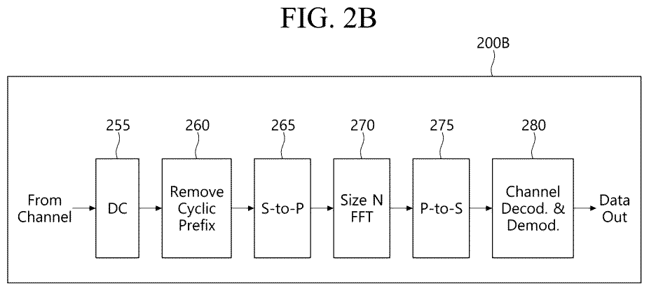

FIG. 2A shows an example of a wireless transmit path 200A in accordance with an embodiment. FIG. 2B shows an example of a wireless receive path 200B in accordance with an embodiment. In the following description, a transmit path 200A may be implemented in a gNB/BS (such as BS 102 of FIG. 1), while a receive path 200B may be implemented in a UE (such as UE 111 (SB) of FIG. 1). However, it will be understood that the receive path 200B can be implemented in a BS and that the transmit path 200A can be implemented in a UE. In some embodiments, the receive path 200B is configured to support the codebook design and structure for systems having 2D antenna arrays as described in some embodiments of the present disclosure. That is to say, each of the BS and the UE include transmit and receive paths such that duplex communication (such as a voice conversation) is made possible.

The transmit path 200A includes a channel coding and modulation block 205 for modulating and encoding the data bits into symbols, a serial-to-parallel (S-to-P) conversion block 210, a size N Inverse Fast Fourier Transform (IFFT) block 215 for converting N frequency-based signals back to the time domain before they are transmitted, a parallel-to-serial (P-to-S) block 220 for serializing the parallel data block from the IFFT block 215 into a single datastream (noting that BSs/UEs with multiple transmit paths may each transmit a separate datastream), an add cyclic prefix block 225 for appending a guard interval that may be a replica of the end part of the orthogonal frequency domain modulation (OFDM) symbol (or whatever modulation scheme is used) and is generally at least as long as the delay spread to mitigate effects of multipath propagation. Alternatively, the cyclic prefix may contain data about a corresponding frame or other unit of data. An up-converter (UC) 230 is next used for modulating the baseband (or in some cases, the intermediate frequency (IF)) signal onto the carrier signal to be used as an RF signal for transmission across an antenna.

The receive path 200B essentially includes the opposite circuitry and includes a down-converter (DC) 255 for removing the datastream from the carrier signal and restoring it to a baseband (or in other embodiments an IF) datastream, a remove cyclic prefix block 260 for removing the guard interval (or removing the interval of a different length), a serial-to-parallel (S-to-P) block 265 for taking the datastream and parallelizing it into N datastreams for faster operations, a multi-input size N Fast Fourier Transform (FFT) block 270 for converting the N time-domain signals to symbols into the frequency domain, a parallel-to-serial (P-to-S) block 275 for serializing the symbols, and a channel decoding and demodulation block 280 for decoding the data and demodulating the symbols into bits using whatever demodulating and decoding scheme was used to initially modulate and encode the data in reference to the transmit path 200A.

As a further example, in the transmit path 200A of FIG. 2A, the channel coding and modulation block 205 receives a set of information bits, applies coding (such as a low-density parity check (LDPC) coding), and modulates the input bits (such as with Quadrature Phase Shift Keying (QPSK), Quadrature Amplitude Modulation (QAM), Orthogonal Frequency Domain Multiple Access (OFDMA), or other current or future modulation schemes) to generate a sequence of frequency-domain modulation symbols. The serial-to-parallel block 210 converts (such as de-multiplexes) the serial modulated symbols to parallel data to generate N parallel symbol streams, where as noted, N is the IFFT/FFT size used in the BS 102 and the UE 116 FIG. 1). The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 to generate a serial time-domain signal. The add cyclic prefix block 225 inserts a cyclic prefix to the time-domain signal. The up-converter 230 modulates (such as up-converts) the output of the add cyclic prefix block 225 from baseband (or in other embodiments, an intermediate frequency IF) to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116 (FIG. 1). The down-converter 255 (for example, at UE 116) down-converts the received signal to a baseband or IF frequency, and the remove cyclic prefix block 260 removes the cyclic prefix to generate a serial time-domain baseband signal. The serial-to-parallel block 265 converts or multiplexes the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream. The data stream may then be portioned and processed accordingly using a processor and its associated memory (ies). Each of the BSs 101-103 of FIG. 1 may implement a transmit path 200A that is analogous to transmitting in the downlink to UEs 111-116, Likewise, each of the BSs 101-103 may implement a receive path 200B that is analogous to receiving in the uplink from UEs 111-116. Similarly, to realize bidirectional signal execution, each of UEs 111-116 may implement a transmit path 200A for transmitting in the uplink to BSs 101-103 and each of UEs 111-116 may implement a receive path 200B for receiving in the downlink from gNBs 101-103. In this manner, a given UE may exchange signals bidirectionally with a BS within its range, and vice versa.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation. In addition, although described as using FFT and IFFT, this exemplary implementation is by way of illustration only and should not be construed to limit the scope of this disclosure. For example, other types of transforms, such as Discrete Fourier Transform (DFT) and Inverse Discrete Fourier Transform (IDFT) functions, can be used in lieu of the FFT/IFFT. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions. Additionally, although FIGS. 2A and 2B illustrate examples of wireless transmit and receive paths, various changes may be made to FIGS. 2A and 2B. For example, various components in FIGS. 2A and 2B can be combined, further subdivided, or omitted, and additional components can be added according to particular needs. Also, FIGS. 2A and 2B are meant to illustrate examples of the types of transmit and receive paths that can be used in a wireless network. Any other suitable architectures can be used to support wireless communications in a wireless network. For example, the functions performed by the modules in FIGS. 2A and 2B may be performed by a processor executing the correct code in memory corresponding to each module.

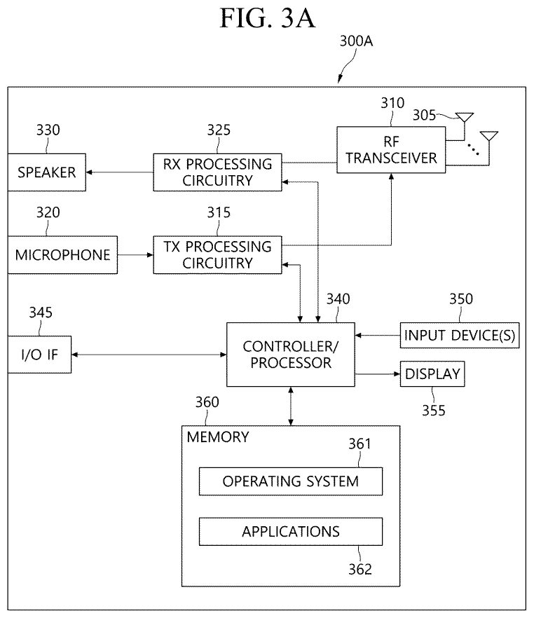

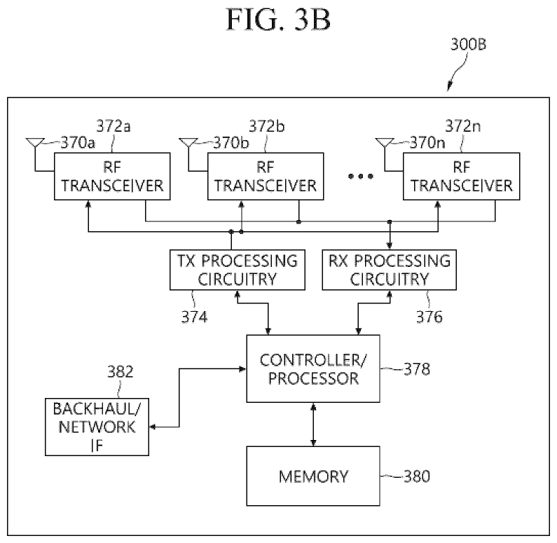

FIG. 3A shows an example of a user equipment (“UE”) 300A (which may be UE 116 in FIG. 1, for example, or another UE) in accordance with an embodiment. It should be underscored that the embodiment of the UE 300A illustrated in FIG. 3A is for illustrative purposes only, and the UEs 111-116 of FIG. 1 can have the same or similar configuration. However, UEs come in a wide variety of configurations, and the UE 300A of FIG. 3A does not limit the scope of this disclosure to any particular implementation of a UE. Referring now to the components of FIG. 3A, the UE 300A includes an antenna 305 (which may be a single antenna or an array or plurality thereof in other UEs), a radio frequency (RF) transceiver 310, transmit (TX) processing circuitry 315 coupled to the RF transceiver 310, a microphone 320, and receive (RX) processing circuitry 325. The UE 300A also includes a speaker 330 coupled to the receive processing circuitry 325, a main processor 340, an input/output (I/O) interface (IF) 345 coupled to the processor 340, a keypad (or other input device(s)) 350, a display 355, and a memory 360 coupled to the processor 340. The memory 360 includes a basic operating system (OS) program 361 and one or more applications 362, in addition to data. In some embodiments, the display 355 may also constitute an input touchpad and in that case, it may be bidirectionally coupled with the processor 340.

The RF transceiver may include more than one transceiver, depending on the sophistication and configuration of the UE. The RF transceiver 310 receives from antenna 305, an incoming RF signal transmitted by a BS of the network 100. The RF transceiver sends and receives wireless data and control information. The RF transceiver is operable coupled to the processor 340, in this example via TX processing circuitry 315 and RF processing circuitry 325. The RF transceiver 310 may thereupon down-convert the incoming RF signal to generate an intermediate frequency (IF) or baseband signal. In some embodiments, the down-conversion may be performed by another device coupled to the transceiver. The IF or baseband signal is sent to the RX processing circuitry 325, which generates a processed baseband signal by filtering, decoding, and/or digitizing the baseband or IF signal. The RX processing circuitry 325 transmits the processed baseband signal to the speaker 330 (such as in the context of a voice call) or to the main processor 340 for further processing (such as for web browsing data or any number of other applications). The TX processing circuitry 315 receives analog or digital voice data from the microphone 320 or, in other cases, TX processing circuitry 315 may receive other outgoing baseband data (such as web data, e-mail, or interactive video game data) from the main processor 340. The TX processing circuitry 315 encodes, multiplexes, and/or digitizes the outgoing baseband data to generate a processed baseband or IF signal. The RF transceiver 310 receives the outgoing processed baseband or IF signal from the TX processing circuitry 315 and up-converts the baseband or IF signal to an RF signal that is transmitted via the antenna 305. The same operations may be performed using alternative methods and arrangements without departing from the spirit or scope of the present disclosure.

The main processor 340 can include one or more processors or other processing devices and execute the basic OS program 361 stored in the memory 360 to control the overall operation of the UE 116. For example, the main processor 340 can control the reception of forward channel signals and the transmission of reverse channel signals by the RF transceiver 310, the RX processing circuitry 325, and the TX processing circuitry 315 in accordance with well-known principles. In some embodiments, the main processor 340 includes at least one microprocessor or microcontroller. The transceiver 310 coupled to the processor 340, directly or through intervening elements. The main processor 340 is also capable of executing other processes and programs resident in the memory 360, such as CLTM in wireless communication systems as described in embodiments of the present disclosure. The main processor 340 can move data into or out of the memory 360 as required by an executing process. In some embodiments, the main processor 340 is configured to execute the applications 362 based on the OS program 361 or in response to signals received from BSs or an operator of the UE. The main processor 340 is also coupled to the I/O interface 345, which provides the UE 300A with the ability to connect to other devices such as laptop computers and handheld computers. The I/O interface 345 is the communication path between these accessories and the main controller 340. The main processor 340 is also coupled to the keypad 350 and the display unit 355. The operator of the UE 300A can use the keypad 350 to enter data into the UE 300A. The display 355 may be a liquid crystal display or other display capable of rendering text and/or at least limited graphics, such as from web sites. The memory 360 is coupled to the main processor 340. Part of the memory 360 can include a random-access memory (RAM), and another part of the memory 360 can include a Flash memory or other read-only memory (ROM).

The UE 300A of FIG. 3A may also include additional or different types of memory, including dynamic random-access memory (DRAM), non-volatile flash memory, static RAM (SRAM), different levels of cache memory, etc. While the main processor 340 may be a complex-instruction set computer (CISC)-based processor with one or multiple cores, it was noted that in other embodiments, the processor may include a plurality of processors. The processor(s) may also include a reduced instruction set computer (RISC)-based processor. The various other components of UE 300A may include separate processors, or they may be controlled in part or in full by firmware or middleware. For example, any one or more of the components of UE 300A may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the UE 300A may rely on middleware or firmware, updates of which may be received from time to time. For smartphones and other UEs whose objective is typically to be compact, the hardware design may be implemented to reflect this smaller aspect ratio. The antenna(s) may stick out of the device, or in other UEs, the antenna(s) may be implanted in the UE body. The display panel may include a layer of indium tin oxide or a similar compound to enable the display to act as a touchpad. In short, although FIG. 3A illustrates one example of UE 300A, various changes may be made to FIG. 3A without departing from the scope of the disclosure. For example, various components in FIG. 3A can be combined, further subdivided, or omitted and additional components can be added according to particular needs. As one example noted above, the main processor 340 can be divided into multiple processors, such as one or more central processing units (CPUs) and one or more graphics processing units (GPUs). Also, while FIG. 3A may include a UE (e.g., UE 116 in FIG. 1) configured as a mobile telephone or smartphone, UEs can be configured to operate as other types of mobile or stationary devices. For example, UEs may be incorporated in tower desktop computers, tablet computers, notebooks, workstations, and servers.

FIG. 3B shows an example of a BS 300B in accordance with an embodiment. A non-exhaustive example of a BS 300B may be that of BS 102 in FIG. 1. As noted, the terminology BS and gNB may be used interchangeably for purposes of this disclosure. The embodiment of the BS 300B shown in FIG. 3B is for illustration only, and other BSs of FIG. 1 can have the same or similar configuration. However, BSs/gNBs come in a wide variety of configurations, and it should be emphasized that the BS shown in FIG. 3B does not limit the scope of this disclosure to any particular implementation of a BS. For example, BS 101 and BS 103 can include the same or similar structure as BS 102 in FIG. 1 or BS 300B (FIG. 3B), or they may have different structures. As shown in FIG. 3B, the BS 300B includes multiple antennas 370a-370n, multiple corresponding RF transceivers 372a-372n, transmit (TX) processing circuitry 374, and receive (RX) processing circuitry 376. The transceivers 372a-372N are coupled to a processor, directly or through intervening elements. In certain embodiments, one or more of the multiple antennas 370a-370n include 2D antenna arrays. The BS 300B also includes a controller/processor 378 (hereinafter “processor 378”), a memory 380, and a backhaul or network interface 382. The RF transceivers 372a-372n receive, from the antennas 370a-370n, incoming RF signals, such as signals transmitted by UEs or other BSs. The RF transceivers 372a-372n down-convert the incoming respective RF signals to generate IF or baseband signals. The IF or baseband signals are sent to the RX processing circuitry 376, which generates processed baseband signals by filtering, decoding, and/or digitizing the baseband or IF signals. The RX processing circuitry 376 transmits the processed baseband signals to the controller/processor 378 for further processing. The TX processing circuitry 374 receives analog or digital data (such as voice data, web data, e-mail, interactive video game data, or data used in a machine learning program, etc.) from the processor 378. The TX processing circuitry 374 encodes, multiplexes, and/or digitizes the outgoing baseband data to generate processed baseband or IF signals. The RF transceivers 372a-372n receive the outgoing processed baseband or IF signals from the TX processing circuitry 374 and up-convert the baseband or IF signals to RF signals that are transmitted via the antennas 370a-370n. It should be noted that the above is descriptive in nature; in actuality not all antennas 370-370n need be simultaneously active.

The processor 378 can include one or more processors or other processing devices that control the overall operation of the BS 300B. For example, the processor 378 can control the reception of forward channel signals and the transmission of reverse channel signals by the RF transceivers 372a-372n, the RX processing circuitry 376, and the TX processing circuitry 374 in accordance with well-known principles. The processor 378 can support additional functions as well, such as more advanced wireless communication functions. For instance, the processor 378 can perform the blind interference sensing (BIS) process, such as performed by a BIS algorithm, and decode the received signal subtracted by the interfering signals. Any of a wide variety of other functions can be supported in the BS 300B by the processor 378. In some embodiments, the processor 378 includes at least one microprocessor or microcontroller, or an array thereof. The processor 378 is also capable of executing programs and other processes resident in the memory 380, such as a basic operating system (OS). The processor 378 is also capable of supporting CLTM in wireless communication systems as described in embodiments of the present disclosure. In some embodiments, the controller/processor 378 supports communications between entities, such as web RTC. The processor 378 can move data into or out of the memory 380 as required by an executing process. A backhaul or network interface 382 allows the BS 300B to communicate with other devices or systems over a backhaul connection or over a network. The interface 382 can support communications over any suitable wired or wireless connection(s). For example, when the BS 300B is implemented as part of a cellular communication system (such as one supporting 5G, 5G-A, LTE, or LTE-A, etc.), the interface 382 can allow the BS 102 (FIG. 1) to communicate with other BSs over a wired or wireless backhaul connection. Referring back to FIG. 3B, the interface 382 can allow the BS 102 to communicate over a wired or wireless local area network or over a wired or wireless connection to a larger network (such as the Internet). The interface 382 includes any suitable structure supporting communications over a wired or wireless connection, such as an Ethernet or RF transceiver. The memory 380 is coupled to the processor 378. Part of the memory 380 can include a RAM, and another part of the memory 380 can include a Flash memory or other ROM. In certain exemplary embodiments, a plurality of instructions, such as a Bispectral Index Algorithm (BIS) may be stored in memory. The plurality of instructions are configured to cause the processor 378 to perform the BIS process and to decode a received signal after subtracting out at least one interfering signal determined by the BIS algorithm.

As described in more detail below, the transmit and receive paths of the BS 102 (implemented in the example of FIG. 3B as BS 300B using the RF transceivers 372a-372n, TX processing circuitry 374, and/or RX processing circuitry 376) support communication with aggregation of frequency division duplex (FDD) cells or time division duplex (TDD) cells, or some combination of both. That is, communications with a plurality of UEs can be accomplished by assigning an uplink of transceiver to a certain frequency and establishing the downlink using a different frequency (FDD). In TDD, the uplink and downlink divisions are accomplished by allotting certain times for uplink transmission to the BS and other times for downlink transmission from the BS to a UE. Although FIG. 3B illustrates one example of a BS 300B which may be similar or equivalent to BS 102 (FIG. 1), various changes may be made to FIG. 3B. For example, the BS 300B can include any number of each component shown in FIG. 3B. As a particular example, an access point can include multiple interfaces 382, and the processor 378 can support routing functions to route data between different network addresses. As another example, while described relative to FIG. 3B for simplicity as including a single instance of TX processing circuitry 374 and a single instance of RX processing circuitry 376, the BS 300B can include multiple instances of each (such as one transmission or receive per RF transceiver).

As an example, Release 13 of the LTE standard supports up to 16 CSI-RS [channel status information-reference signal] antenna ports which enable a BS to be equipped with a large number of antenna elements (such as 64 or 128). In this case, a plurality of antenna elements is mapped onto one CSI-RS port. Furthermore, up to 32 CSI-RS ports are supported in Rel. 14 LTE. For next generation cellular systems such as 5G, the maximum number of CSI-RS ports may be greater. The CSI-RS is a type of reference signal transmitted by the BS to the UE to allow the UE to estimate the downlink radio channel quality. The CSI-RS can be transmitted in any available OFDM symbols and subcarriers as configured in the radio resource control (RRC) message. The UE measures various radio channel qualities (time delay, signal-to-noise ratio, power, etc.) and reports the results to the BS.

The BS 300B of FIG. 3B may also include additional or different types of memory 380, including dynamic random-access memory (DRAM), non-volatile flash memory, static RAM (SRAM), different levels of cache memory, etc. While the main processor 378 may be a complex-instruction set computer (CISC)-based processor with one or multiple cores, in other embodiments, the processor may include a plurality or an array of processors. Often in embodiments, the processing power and requirements of the BS may be much higher than that of the typical UE, although this is not required. Some BSs may include a large structure on a tower or other structure, and their immobility accords them access to fixed power without the need for any local power except backup batteries in a blackout-type event. The processor(s) 378 may also include a reduced instruction set computer (RISC)-based processor or an array thereof. The various other components of BS 300B may include separate processors, or they may be controlled in part or in full by firmware or middleware. For example, any one or more of the components of BS 300B may include one or more digital signal processors (DSPs) for executing specific tasks, one or more field programmable gate arrays (FPGAs), one or more programmable logic devices (PLDs), one or more application specific integrated circuits (ASICs) and/or one or more systems on a chip (SoC) for executing the various tasks discussed above. In some implementations, the BS 300B may rely on middleware or firmware, updates of which may be received from time to time. In some configurations, the BS may include layers of stacked motherboards to accommodate larger processing needs, and to process channel state information (CSI) and other data received from the UEs in the vicinity.

In short, although FIG. 3B illustrates one example of a BS, various changes may be made to FIG. 3B without departing from the scope of the disclosure. For example, various components in FIG. 3B can be combined, further subdivided, or omitted, and additional components can be added according to particular needs. As one example noted above, the main processor 378 can be divided into multiple processors, such as one or more central processing units (CPUs) and one or more graphics processing units (GPUs)—or in some cases, multiple motherboards for enhanced functionality. The BS may also include substantial solid-state drive (SSD) memory, or magnetic hard disks to retain data for prolonged periods. Also, while one example of BS 300B was that of a structure on a tower, this depiction is exemplary only, and the BS may be present in other forms in accordance with well-known principles.

A description of various aspects of the disclosure is provided below. The text in the written description and corresponding figures are provided solely as examples to aid the reader in understanding the principles of the disclosure. They are not intended and are not to be construed as limiting the scope of this disclosure in any manner. Although certain embodiments and examples have been provided, it will be apparent to those skilled in the art based on the disclosures herein that changes in the embodiments and examples shown may be made without departing from the scope of this disclosure.

Aspects, features, and advantages of the disclosure are readily apparent from the following detailed description. Several embodiments and implementations are shown for illustrative purposes. The disclosure is also capable of further and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

Although exemplary descriptions and embodiments to follow employ orthogonal frequency division multiplexing (OFDM) or orthogonal frequency division multiple access (OFDMA) for purposes of illustration, other encoding/decoding techniques may be used. That is, this disclosure can be extended to other OFDM-based transmission waveforms or multiple access schemes such as filtered OFDM (F-OFDM). In addition, the principles of this disclosure are equally applicable to different encoding and modulation methods altogether. Examples include LDPC, QPSK, BPSK, QAM, and others.

This present disclosure covers several components which can be used in conjunction or in combination with one another, or which can operate as standalone schemes. Given the sheer volume of terms and vernacular used in conveying concepts relevant to wireless communications, practitioners in the art have formulated numerous acronyms to refer to common elements, components, and processes. For the reader's convenience, a non-exhaustive list of example acronyms is set forth below. As will be apparent in the text that follows, a number of these acronyms below and in the remainder of the document may be newly created by the inventor, while others may currently be familiar. For example, certain acronyms (e.g., CLTM, etc.) may be formulated by the inventors and designed to assist in providing an efficient description of the unique features within the disclosure. A list of both common and unique acronyms follows.

### Abbreviations:

L1 Layer 1
L2 Layer 2
L3 Layer 3
UE User Equipment
gNB Base Station
NW Network
NR New Radio
3GPP 3rd Generation Partnership Project
WI Work Item
SI Study Item
HO Handover
CHO Conditional Handover
DAPS Dual Active Protocol Stack
BFD Beam Failure Detection
BFR Beam Failure Recovery
SSB System Synchronization and PBCH Block
CSI Channel State Information
RS Reference Signal
TRS Tracking Reference Signal
TRP Transmit/Receive Point
SpCell Special Cell
SCell Secondary Cell
PSCell Primary Secondary Cell
HARQ Hybrid ARQ
NDI New Data Indication
RRC Radio Resource Control
DU Distributed Unit
CU Central Unit
C-RNTI Cell Radio Network Temporary Identifier
CS-RNTI Configured Scheduling Radio Network Temporary Identifier
SPS Semi-Persistent Scheduling
SR Scheduling Request
UL-SCH Uplink Shared Channel
LCP Logical Channel Prioritization
PDU Protocol Data Unit
RSRP Reference Signal Received Power
RSRQ Reference Signal received Quality
SINR Signal to Interference and Noise Ratio
BLER Block Error Rate
CQI Channel Quality Indicator
TA Timing Advance
MIB Master Information Block
SIB System Information Block
CORESET Control Resource Set
RAR Random Access Response
DL Downlink
UL Uplink
DCI Downlink Control Information
PDCCH Physical Downlink Control Channel
PUSCH Physical Uplink Shared Channel
PUCCH Physical Uplink Control Channel
PUSCH Physical Downlink Shared Channel
SRS Sounding Reference Signal
RACH Random Access Channel
PRACH Physical Random Access Channel
IE Information Element
TCI Transmission Configuration Indicator
RA Random Access

The following documents are hereby incorporated by reference in their entirety into the present disclosure as if fully set forth herein: i) 3GPP TS 38.300 v17.5.0; ii) 3GPP TS 38.331 v17.5.0; and iii) 3GPP TS 38.321 v17.5.0.

3GPP (Third-Generation Partnership Project) has developed technical specifications and standards to define the new 5G radio-access technology, known as 5G NR. Mobility handling is a critical aspect in any mobile communication system including 5G system. For a UE in connected mode, the mobility is controlled by the network with the assistance from the UE to maintain an optimal connection quality. Based on the measured values of radio link quality of the serving cell (or source cell) and neighboring cell(s) reported by the UE, the network may hand over the UE to a neighboring cell that can provide better radio conditions when the UE is experiencing a degraded connection to the serving cell. The fundamental procedure of network-controlled mobility in connected mode is developed in Releasee 15 NR of 3GPP. Further, in release-16 NR, enhancements to network-controlled mobility in connected mode are introduced to mitigate connection interruption during handover procedure. Specifically, two enhanced handover mechanisms are developed, known as conditional handover (CHO) and dual active protocol stack (DAPS).

Generally, in a CHO procedure, the UE is allowed to decide whether to execute the handover when certain execution conditions are met. Upon receiving CHO configuration in an RRC reconfiguration message which includes configurations for multiple candidate cells, a UE initiates evaluating the CHO execution conditions for the candidate cell(s). If at least one CHO candidate cell satisfies the corresponding CHO execution condition, the UE detaches from the source cell, applies the configuration of the target cell, and synchronizes to the target cell. The UE thereupon completes the CHO procedure by sending an “RRC reconfiguration complete” message to the target cell. The UE releases the stored CHO configurations after successful completion of the handover procedure.

More specifically, the CHO is a handover that is executed by the UE when one or more handover execution conditions are met. The UE starts evaluating the execution conditions upon receiving the CHO configuration and stops evaluating the execution conditions once a handover is executed.

The following principles are applicable to the CHO. First, the CHO configuration includes the configuration of CHO candidate cell(s) generated by the candidate BS(s) (e.g., gNB) and the execution condition(s) generated by the source (or serving) BS. The execution condition(s) may include one or two trigger conditions (such as CHO events A3/A5). Only a single RS type is supported, and at most two different trigger quantities (e.g., RSRP and RSRQ, RSRP and SINR) can be configured simultaneously for evaluating the CHO execution condition of a single candidate cell. Further, before any CHO execution condition is satisfied, upon reception of a HO command (that is, without a CHO configuration), the UE executes the HO procedure regardless of any previously received CHO configuration. While executing CHO, or more specifically from the time when the UE starts synchronization with target cell, UE does not monitor the source cell. These principles apply generally to the CHO in existing implementations.

For the mobility in connected mode, the conventional handover, including CHO, is initiated by the network via higher layer signaling (e.g., RRC message) based on Layer 3 (L3) measurements. However, this procedure involves increased latency, signaling overhead, and interruption time that may become the key issue in some scenarios with frequency handover, for example and without limitation, when the UE is in high-speed vehicular and Frequency Range 2 (FR2) deployment. Therefore, a reduction in increased latency, signaling overhead, and interruption time in the handover procedure is needed. As such, a need arises for Layer 1/Layer 2 (L1/L2) Triggered Mobility (LTM), in which the handover can be triggered using L1/L2 signaling based on L1 physical layer measurements. More specifically, the LTM may refer to a mobility mechanism whereby UE switches from the source cell (or serving cell) to a target cell with beam-switching triggered by L1/L2 signaling. The beam switching decision is based on L1 measurements on beams among neighboring cells. Furthermore, the cell switch can be triggered by L1/L2 signaling from the network or triggered by the fulfillment of pre-configured conditional event, for example, in conditional LTM (CLTM) procedure. The CLTM may refer to an LTM procedure where execution conditions are evaluated for one or more multiple candidate cells based on L1 measurement and the cell switch is executed only when one or more execution conditions are met.

To reduce the delay and the overload in the handover procedure, RACH-less CHO or CLTM is desired. In this disclosure, RACH-less HO may refer to a handover procedure without random access procedure to the target cell when executing the hand over. The RACH-less HO can be applied to conditional mobility. In this disclosure, the conditional mobility may refer to a handover procedure that is triggered by the fulfilment of pre-configured conditions for candidate cell(s), including, for example and without limitation, CHO, CLTM, conditional PSCell addition (CPA), and conditional PSCell change (CPC).

The disclosure provides RACH-less HO procedure in conditional mobility. The RACH-less HO or RACH-less cell switch may be performed based on the validity of the timing advance (TA) information and configured uplink (UL) grant for the initial uplink (UL) transmission to the target cell. The terms ‘cell switch’ and ‘handover’ are used interchangeably in this disclosure.

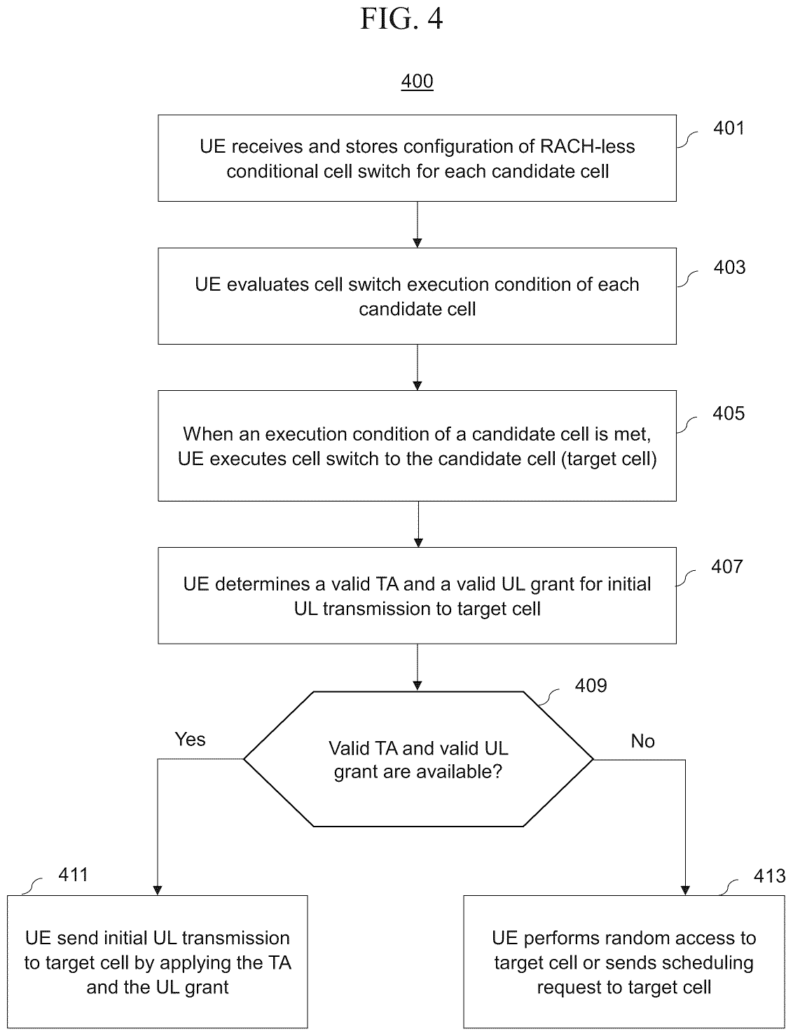

FIG. 4 shows an example process 400 for RACH-less conditional cell switch in accordance with an embodiment. For explanatory and illustration purposes, the example process 400 may be performed by an UE. Although one or more operations are described or shown in particular sequential order, in other embodiments the operations may be rearranged in a different order, which may include performance of multiple operations in at least partially overlapping time periods.

Referring to FIG. 4, the process 400 may begin in operation 401. In operation 401, UE receives and stores the configuration of RACH-less conditional cell switch for each candidate cell. There can be multiple candidate cells for the conditional cell switch. The configuration may include, for example and without limitation, execution condition to be evaluated for candidate cells, TA information, and/or configured UL grant for initial UL transmission to the candidate cells for RACH-less cell switch.

In operation 403, UE evaluates the execution condition for each candidate cell.

In operation 405, when the execution condition of a candidate cell is met or fulfilled, UE selects the candidate cell as a target cell (or applicable cell) and then executes cell switch to the target cell.

In operation 407, when executing cell switch, UE determines whether a valid TA and a valid UL grant for initial UL transmission to the target cell are available. The initial UL transmission may include ‘RRCReconfigurationComplete’ message. The valid TA may be determined or obtained in various manners. In an embodiment, the valid TA may be determined based on pre-configured TA information, if included in the configuration for the target cell. In an embodiment, the valid TA may be determined based on time-based event, distance-based event, or validity information, if included in the configuration for the target cell. In an embodiment, the valid TA may be obtained by early TA acquisition when RACH resource is pre-configured in the configuration for the target cell. This allows UE to send PRACH to the target cell before the cell switch. The valid TA may be obtained by UE autonomous estimation when TA estimation configuration is provided in the configuration for the target cell. The valid UL grant also may be determined in various manners. In an embodiment, the valid UL grant may be determined based on pre-configured UL grant, if included in the configuration for the target cell. In an embodiment, the valid UL grant may be determined based on time-based event or validity information, if included in the configuration for the target cell.

In operation 409, when both valid TA and valid UL grant are available, the process 400 proceeds to operation 411. Otherwise, it proceeds to operation 413.

In operation 411, UE sends initial UL transmission (e.g., UL PUSCH) to the target cell by applying the valid TA and the valid UL grant.

In operation 413, one or both of valid TA and valid UL grant are not available. UE performs random access procedure to the target cell or sends scheduling request (SR) to the target cell. In an embodiment, when a valid TA is not available, UE performs random access procedure to the target cell. When a valid TA is available but a valid UL grant is not available, UE sends SR to the target cell.

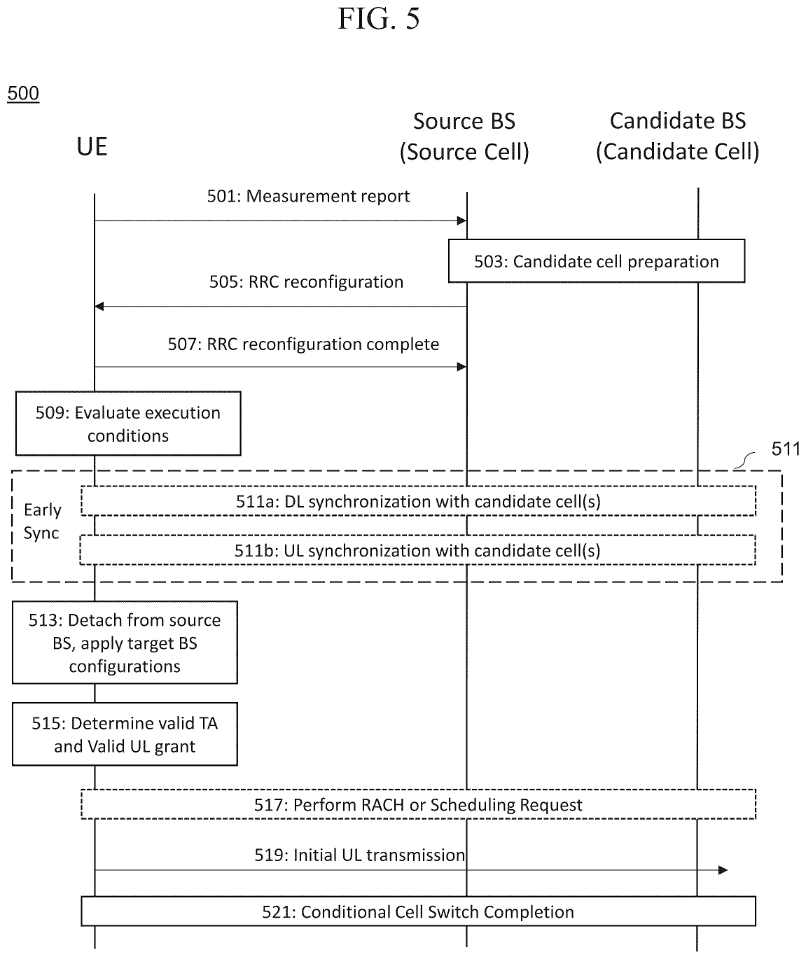

FIG. 5 shows an example process 500 for signaling RACH-less conditional cell switch in accordance with an embodiment. For explanatory and illustration purposes, the example process 500 may be performed by an UE, a source BS (source cell), and one or more candidate BSs (candidate cells). Although one or more operations are described or shown in particular sequential order, in other embodiments the operations may be rearranged in a different order, which may include performance of multiple operations in at least partially overlapping time periods.

Referring to FIG. 5, the process 500 may begin in operation 501. In operation 501, UE transmits a measurement report to Source BS. Source BS may be referred to as Source Cell in this embodiment. For example and without limitation, UE may report the signal quality (e.g., RSRP) of the source cell and candidate cells.

In operation 503, Source BS determines to configure RACH-less cell switch and initiates cell preparation for RACH-less cell switch with one or more Candidate Cells.

In operation 505, Source BS transmits an RRCReconfiguration message to UE, including one or more candidate cell configurations for conditional cell switch. The configurations may include TA information and/or configured UL grant for one or more candidate cells.

In operation 507, UE stores one or more candidate cell configurations for conditional cell switch. Then, UE transmits an RRCReconfigurationComplete message to Source BS.

In operation 509, UE starts evaluating execution conditions of the candidate cells for conditional cell switch. The execution condition for a candidate cell may include RRM (Radio Resource Management) measurement event, time-based event, and/or distance-based event.

In operation 511, UE may perform early synchronization. More specifically, in operation 511a, UE may perform downlink (DL) synchronization with candidate cell(s) before cell switch execution. Additionally, in operation 511b, if configured by the network, UE may perform early TA acquisition with candidate cell(s) before cell switch execution. Early TA acquisition may be performed by random access procedure towards candidate cell(s). UE needs to maintain the validity of the early acquired TA.

In operation 513, when at least one candidate cell meets execution condition, UE selects the candidate cell as a target cell. Then, UE detaches from Source Cell and applies the stored candidate cell configuration for the selected candidate cell (target cell or target BS).

In operation 515, UE determines whether it has a valid TA and/or a valid UL grant for initial UL transmission to the target cell, for example and without limitation, based on the TA information and/or configured UL grant included in the candidate cell configuration. When both a valid TA and a valid UL grant are available, the process 500 proceeds to operation 519. Otherwise, it proceeds to operation 517.

In operation 517, when UE does not have valid TA and/or valid UL grant of the target cell, UE performs random access procedures or scheduling request towards the target cell. In an embodiment, when a valid TA is not available, UE performs random access procedure to the target cell. When a valid TA is available, but a valid UL grant is not available, UE sends SR to the target cell.

In operation 519, when UE has a valid TA and a valid UL grant of the target cell, UE transmits initial UL transmission, for example, in PUSCH to the target cell. The initial UL transmission may include RRCReconfigurationComplete message. In operation 519, the random access produce is skipped (RACH-less cell switch).

In operation 521, when UE has performed the random access procedure to the target cell, it determines that cell switch execution is successfully completed once the random access is successfully completed. For RACH-less cell switch, UE determines that the cell switch execution is successfully completed when it confirms that the network has successfully received the initial UL transmission. UE can confirm successful reception of the initial UL transmission by receiving a PDDCH addressing the UE's C-RNTI in the target cell. The target cell schedules new downlink and/or uplink transmissions following the initial UL transmission.

UE may not automatically release candidate cell configurations but maintain them by addition, modification, and/or release according to network reconfiguration. In some embodiments, operations 509 to 521 may be performed multiple times for subsequent cell switches using the candidate cells configurations provided in operation 505.

In some embodiments, the candidate cell configuration in operation 505 includes TA information that includes a TA parameter (N_TA) to be applied for the initial UL transmission (e.g., UL PUSCH) to the selected candidate cell (i.e., the target cell). When the execution condition of a candidate cell is met and the candidate cell is selected as the target cell in operation 513, UE determines that the TA parameter (N_TA) is valid for sending the initial UL transmission to the target cell. UE may apply the TA parameter (N_TA) for a configured or an indicated Timing Advance Group (TAG). In an implementation, a TAG ID can be associated with the TA parameter (N_TA). In another implementation, UE may apply the TA parameter (N_TA) for the TAG with ID 0.

In some embodiments, the candidate cell configuration in operation 505 includes TA information that includes a TA parameter (N_TA) to be applied for the initial UL transmission (e.g., UL PUSCH) to the target cell. The candidate cell configuration in operation 505 also includes execution condition of the candidate cell which includes a time-based event specifying a time window. The time-based event can be configured to determine the validity of the candidate cell or specifically configured to determine the validity of the TA information of the candidate cell. UE may determine that the time-based event is triggered or fulfilled (i.e., entering condition is satisfied) if the measured time at UE is within the time window specified in the time-based event. UE may determine that the time-based event is not triggered or fulfilled (i.e., leaving condition is satisfied) if the measure time at UE is not within the time window specified in the time-based event. The measured time may refer to a time when UE determines that the execution condition of the candidate cell is met. When the execution condition of a candidate cell is met and the candidate cell is selected as the target cell in operation 513, UE determines that the TA parameter (N_TA) is valid for sending the initial UL transmission to the target cell. UE may apply the TA parameter (N_TA) for a configured or an indicated TAG. In an implementation, a TAG ID can be associated with the TA parameter (N_TA). In another implementation, UE may apply the TA parameter (N_TA) for the TAG with ID 0.

In some embodiments, the candidate cell configuration in operation 505 includes TA information that includes a TA parameter (N_TA) to be applied for the initial UL transmission (e.g., UL PUSCH) to the target cell. The candidate cell configuration in operation 505 also includes execution condition of the candidate cell which includes a distance-based event specifying a reference location and a distance threshold. In an implementation, UE may determine that the distance-based event is triggered or fulfilled (i.e., entering condition is satisfied) if the distance between a real-time measured UE location and a real-time reference location is smaller than the distance threshold. UE may determine that the distance-based event is not triggered or fulfilled (i.e., leaving condition is satisfied) if the distance between the real-time measured UE location and the real-time reference location is larger than the distance threshold. In another implementation, UE may determine that the distance-based event is triggered or fulfilled (i.e., entering condition is satisfied) if the distance between the real-time measured UE location and the real-time reference location is larger than the distance threshold. UE may determine that the distance-based event is not triggered or fulfilled (i.e., leaving condition is satisfied) if the distance between the real-time measured UE location and the real-time reference location is smaller than the distance threshold. When the execution condition of a candidate cell is met and the candidate cell is selected as the target cell in operation 513, UE determines that the TA parameter (N_TA) is valid for sending the initial UL transmission to the target cell. UE may apply the TA parameter (N_TA) for a configured or an indicated TAG. In an implementation, a TAG ID can be associated with the TA parameter (N_TA). In another implementation, UE may apply the TA parameter (N_TA) for the TAG with ID 0.

In some embodiments, the candidate cell configuration in operation 505 includes TA information that includes a TA parameter (N_TA) to be applied for the initial UL transmission (e.g., UL PUSCH) to the target cell. The candidate cell configuration in operation 505 also includes execution condition of the candidate cell which includes a distance-based event specifying a reference location at a reference time and a distance threshold. In an implementation, UE may determine that the distance-based event is triggered or fulfilled (i.e., entering condition is satisfied) if the distance between a real-time measured UE location and a real-time reference location is smaller than the distance threshold. UE may determine that the distance-based event is not triggered or fulfilled (i.e., leaving condition is satisfied) if the distance between the real-time measured UE location and the real-time reference location is larger than the distance threshold. In another implementation, UE may determine that the distance-based event is triggered or fulfilled (i.e., entering condition is satisfied) if the distance between the real-time measured UE location and the real-time reference location is larger than the distance threshold. UE may determine that the distance-based event is not triggered or fulfilled (i.e., leaving condition is satisfied) if the distance between the real-time measured UE location and the real-time reference location is smaller than the distance threshold. UE may estimate the real-time reference location based on the movement information associated with the reference location of the candidate cell. The movement information may be provided in the candidate cell configuration in the form of satellite ephemeris parameters, moving speed parameters, moving direction parameters, and/or velocity parameters. The reference time may be provided in the candidate cell configuration in the form of satellite epoch time, UTC (Coordinated Universal Time) time, SFN (System Frame Number), subframe, or symbol numbers. When the execution condition of a candidate cell is met and the candidate cell is selected as the target cell in operation 513, UE determines that the TA parameter (N_TA) is valid for sending the initial UL transmission to the target cell. UE may apply the TA parameter (N_TA) for a configured or an indicated TAG. In an implementation, a TAG ID can be associated with the TA parameter (N_TA). In another implementation, UE may apply the TA parameter (N_TA) for the TAG with ID 0.

In some embodiments, the candidate cell configuration in operation 505 includes a UE autonomous TA estimation configuration that includes the parameters to be applied for TA estimation at UE. In an implementation, a reference TA, validity information, and/or reference signals for TA estimation are provided in the UE autonomous TA estimation configuration. In another implementation, satellite ephemeris, common TA parameters, validity duration for a timer (e.g., T430), and/or epoch time are provided for a non-terrestrial network (NTN) candidate cell in the UE autonomous TA estimation configuration. If the UE autonomous TA estimation configuration is provided for a candidate cell, UE performs TA estimation for the candidate cell based on the configuration and maintains the validity of the estimated TA. For example, UE maintains the validity of candidate cell's ephemeris and common TA parameters by running the timer T430 for an NTN candidate cell. UE may perform the TA estimation for the candidate cell by calculating the Round-Trip Time (RTT) between the UE location and satellite position while a timer (T430) is running. The validity of the estimated TA may depend on the validity of the ephemeris and common TA parameters. UE may determine that the estimated TA is valid if the applied ephemeris and common TA parameters are valid, for example, as long as T430 for the candidate cell is running. UE may determine the estimated TA is no longer valid if T430 for the candidate cell is expired. When the execution condition of a candidate cell is met, the candidate cell is selected as the target cell in operation 513, and the UE estimated TA for the candidate cell is valid, UE determines that the estimated TA is valid for sending the initial UL transmission to the target cell. UE may apply the estimated TA for a configured or indicated TAG. In an implementation, a TAG ID can be associated with the estimated TA. In another implementation, UE may apply the estimated TA for the TAG with ID 0.

In some embodiments, the candidate cell configuration in operation 505 includes an early TA acquisition configuration that includes a RACH configuration for the candidate cell. If the early TA acquisition configuration is provided for the candidate cell, UE may acquire TA for the candidate cell by sending PRACH to the candidate cell and receiving, from the source cell, TA information of the candidate cell in random access response (RAR) or MAC CE (Control Element). The TA information may include TA value and/or TA validity timer duration. UE maintains the validity timer of the TA for the candidate cell. UE determines that the TA is valid if the validity timer is running. Conversely, UE determines that the TA is invalid if the validity timer expires. When the execution condition of a candidate cell is met, the candidate cell is selected as the target cell in operation 513, and the early acquired TA of the candidate cell is valid, UE determines that the TA is valid for sending the initial UL transmission to the target cell. UE may apply the early acquired TA for a configured or an indicated TAG. In an implementation, a TAG ID can be associated with the early acquired TA. In another implementation, UE may apply the early acquired TA for the TAG with ID 0.

In some embodiments, the candidate cell configuration in operation 505 includes one or more configured grants (i.e., UL grant). Each configured grant (CG) includes periodical CG occasions for PUSCH transmission. Each CG may be associated with a respective one of one or more SSBs, CSI-Rs, or TRSs, for example, in a way that CG occasions are mapped to SSBs, CSI-RSs, or TRSs. A RSRP threshold can be configured for beam selection and CG occasion selection. When the execution condition of the candidate cell is met, the candidate cell is selected as the target cell in operation 505, and at least one of SSB, CSI-RS, or TRS associated with a CG has RSRP exceeding the RSRP threshold, UE determines that the CG is valid for the initial UL transmission to the target cell. UE selects an SSB, CSI-RS, or TRS associated with the CG that has RSRP above the RSRP threshold. Then, UE transmits the initial UL transmission (UL PUSCH) at the PUSCH occasion corresponding to the selected SSB, CSI-RS, or TRS.

In some embodiments, the candidate cell configuration in operation 505 includes one or more configured grants (i.e., UL grant). Each configured grant (CG) includes periodical CG occasions for PUSCH transmission. Each CG may be associated with a respective one of one or more SSBs, CSI-Rs, or TRSs, for example, in a way that CG occasions are mapped to SSBs, CSI-RSs, or TRSs. A RSRP threshold can be configured for beam selection and CG occasion selection. The candidate cell configuration in operation 505 also includes execution condition of the candidate cell which includes a time-based event specifying a time window. The time-based event may be configured for the validity of the candidate cell or specifically configured for the validity of the CG of the candidate cell. UE determines that the time-based event is triggered or fulfilled (i.e., entering condition is satisfied) if the measure time at UE is within the time window specified in the time-based event. UE may determine that the time-based event is not triggered or fulfilled (i.e., leaving condition is satisfied) if the measure time at UE is not within the time window specified in the time-based event. The measured time may refer to a time when UE determines that the execution condition of the candidate cell is met. When the execution condition of the candidate cell is met, the candidate cell is selected as the target cell in operation 505, and at least one of SSB, CSI-RS, or TRS associated with a CG has RSRP exceeding the RSRP threshold, UE determines that the CG is valid for the initial UL transmission to the target cell. UE selects an SSB, CSI-RS, or TRS associated with the CG that has RSRP above the RSRP threshold. Then, UE transmits the initial PUSCH at the PUSCH occasion corresponding to the selected SSB, CSI-RS, or TRS.

In some embodiments, the candidate cell configuration in operation 505 includes one or more CGs. Each CG includes periodical CG occasion for PUSH transmission. Each CG may be associated with a respective one of one or more one or more SSBs, CSI-RSs, or TRSs, for example, in a way that CG occasions are mapped to SSBs, CSI-RSs, or TRSs. The candidate cell configuration in operation 505 also includes execution condition of the candidate cell which includes a beam/L1 measurement event. UE determines that the beam/L1 measurement event is triggered or met if the measured quantity of the configured beam satisfies a pre-configured condition. If the execution condition of the candidate cell is met, the candidate cell is selected as the target cell in operation 513, and at least one of SSB, CSI-RS, or TRS satisfying the beam/L1 measurement event is associated with a CG, UE determines that the CG is valid for the initial UL transmission to the target cell. UE selects a beam, SSB, CSI-RS, or TRS that satisfies the beam/L1 measurement event and is associated with the CG. Then, UE transmits the initial PUSCH at the PUSCH occasion corresponding to the selected beam, SSB, CSI-RS, or TRS. In a case that there are multiple beams, SSBs, CSI-RSs, or TRSs satisfying the beam/L1 measurement event, in an embodiment, UE may select the best beam, SSB, CSI-RS, or TRS among the multiple beams, SSBs, CSI-RSs, and TRSs. For example and without limitation, the best beam, SSB, CSI-RS, or TRS may be associated with a L1 measurement quantity. In another embodiment, a threshold (e.g., L1-RSRP threshold) can be configured for beam selection so that UE selects a beam, SSB, CSI-RS, or TRS that exceeds the threshold from among the multiple beams, SSBs, CSI-RSs, and TRSs. In another embodiment, UE may select a beam, SSB, CSI-RS, or TRS among the multiple beams, SSBs, CSI-RSs, and TRSs satisfying the beam/L1 measurement event based on UE implementation.

In some embodiments, the candidate cell configuration in operation 505 includes one or more CGs. Each CG includes periodical CG occasions for PUSCH transmission. Each CG may be associated with a respective one of one or more SSBs, CSI-RSs, or TRSs, for example, in a way that the CG occasions are mapped to SSBs, CSI-RSs, or TRSs. The candidate cell configuration in operation 505 also includes execution condition of the candidate cell which includes a time-based event specifying a time window. The time-based event may be configured for the validity of the candidate cell or specifically configured for the validity of the CG of the candidate cell. UE determines that the time-based event is triggered or fulfilled (i.e., entering condition is satisfied) if the measure time at UE is within the time window specified in the time-based event. UE may determine that the time-based event is not triggered or fulfilled (i.e., leaving condition is satisfied) if the measure time at UE is not within the time window specified in the time-based event. The measured time may refer to a time when UE determines that the execution condition of the candidate cell is met. The candidate cell configuration in operation 505 also includes a beam/L1 measurement event. UE determines that the beam/L1 measurement event is triggered or met if the measured quantity of the configured beam satisfies the pre-configured condition. If the execution condition of the candidate cell is met, the candidate cell is selected as the target cell in operation 513, and at least one of SSB, CSI-RS, or TRS satisfying the beam/L1 measurement is associated with a CG, UE determines that the CG is valid for the initial UL transmission to the target cell. UE selects a beam, SSB, CSI-RS, or TRS that satisfies the beam/L1 measurement event and is associated with the CG. Then, UE transmits the initial PUSCH at the PUSCH occasion corresponding to the selected SSB, CSI-RS, or TRS. In a case that there are multiple beams, SSBs, CSI-RSs, or TRSs satisfying the beam/L1 measurement event, in an embodiment, UE may select the best beam, SSB, CSI-RS, or TRS from among the multiple beams, SSBs, CSI-RSs, and TRSs. For example and without limitation, the best beam, SSB, CSI-RS, or TRS may be associated with a L1 measurement quantity. In another embodiment, a threshold (e.g., L1-RSRP threshold) can be configured for beam selection so that UE selects a beam, SSB, CSI-RS, or TRS that exceeds the threshold from among the multiple beams, SSBs, CSI-RSs, and TRSs. In another embodiment, UE may select a beam, SSB, CSI-RS, or TRS among the multiple beams, SSBs, CSI-RSs, and TRSs satisfying the beam/L1 measurement event based on UE implementation.

In some embodiments, the candidate cell configuration in operation 505 includes one or more multiple CGs. Each CG includes periodical CG occasions for PUSCH transmission. Each CG may be associated with a respective one of one or more SSBs, CSI-RSs, or TRSs, for example, in a way that the CG occasions are mapped to SSBs, CSI-RSs, or TRSs. A RSRP threshold may be configured for beam and CG occasion selection. Each CG may be configured for a validity duration. The validity duration may be indicated by a start time and/or duration. The start time may be signaled in the form of UTC time, SFN, subframe, or symbol numbers. When the execution condition of the candidate cell is met, the candidate cell is selected as target cell in operation 513, at least one of SSB, CSI-RS, or TRS associated with a CG has RSRP exceeding the RSRP threshold, and the measured time at UE is within the validity duration of the CG, UE determines that the CG is valid for the initial UL transmission to the target cell. UE selects an SSB, CSI-RS, or TRS associated to the CG that has RSRP above the RSRP threshold. Then, UE transmits the initial PUSCH at the PUSCH occasion corresponding to the selected SSB, CSI-RS, or TRS.

In some embodiments, the candidate cell configuration in operation 505 includes one or more CGs. Each CG includes periodical CG occasions for PUSCH transmission. Each CG may be associated with a respective one of one or more SSBs, CSI-RSs, or TRSs in a way that CG occasions are mapped to SSBs, CSI-Rs, or TRSs. Each CG may be configured for a validity duration. The validity duration may be indicated by a start time and/or duration. The start time may be signaled in the form of UTC time, SFN, subframe, or symbol numbers. The candidate cell configuration in operation 505 also includes a beam/L1 measurement event. UE determines that the beam/L1 measurement event is triggered or fulfilled if the measured quantity of the configured beam satisfies the configured condition. If the execution condition of the candidate cell is fulfilled, the candidate cell is selected as the target cell in operation 513, and at least one of SSB, CSI-RS, or TRS satisfying the beam/L1 measurement is associated with a CG, and the measured time at UE is within the validity duration of the CG, UE determines that the CG is valid for the initial UL transmission to the target cell. UE selects a beam, SSB, CSI-RS, or TRS that satisfies the beam/L1 measurement event and is associated with the CG. Then, UE transmits the initial PUSCH at the PUSCH occasion corresponding to the selected beam, SSB, CSI-RS, or TRS. In a case that there are multiple beams, SSBs, CSI-RSs, or TRSs satisfying the beam/L1 measurement event, in an embodiment, UE may select the best beam, SSB, CSI-RS, or TRS among the multiple beams, SSBs, CSI-RSs, and TRSs. The best beam, SSB, CSI-RS, or TRS may be associated with a L1 measurement quantity. In another embodiment, a threshold (e.g., L1-RSRP threshold) can be configured for beam selection so that UE selects a beam, SSB, CSI-RS, or TRS that exceeds the threshold from among the multiple beams/SSBs/CSI-RSs/TRSs. In another embodiment, UE may select a beam, SSB, CSI-RS, and TRS among the multiple beams, SSBs, CSI-RSs, and TRSs satisfying the beam/L1 measurement event based on UE implementation.

In some embodiments, the candidate cell configuration in operation 505 may include one or more pairs of TA information and configured UL grant. Each pair may be associated with a specific time window. UE evaluates the condition of a candidate cell for the conditional cell switch. When the condition for the conditional cell switch is met and a measured time (e.g., the time when the condition is met) is within the specific time window, UE identifies a pair of TA information and UL grant that is associated with the specific time window and determines that the TA information and the UL grant are valid. UE executes the conditional cell switch to the candidate cell in a RACH-less procedure by using the TA information and the UL grant when transmitting initial UL transmission to the candidate cell.

One or more embodiments described above can be used individually or in combination to determine the valid TA and the valid UL grant for the initial UL transmission to the target cell. If a valid TA is unavailable, a valid UL grant is unavailable, or neither valid TA nor valid UL grant is available, UE performs random access procedure to the target cell in operation 517. If a valid TA is available but no valid UL grant is available, UE may trigger a scheduling request (SR) in operation 509.

In some embodiments, the condition to determine a valid TA and the condition to determine a valid UL grant may be applied simultaneously in an additive manner to determine RACH-less cell switch in conditional mobility. For example, if UE has a valid TA and a valid UL grant for the target cell, UE performs RACH-less cell switch to the target cell using the valid TA and the valid CG. However, if UE has a valid TA but no valid UL grant for the target cell, UE may perform SR using the valid TA. If UE has neither valid TA nor valid CG for the target cell, UE performs random access procedure to the target cell when executing the cell switch. When UE performs SR, if the buffer status reporting (BSR) procedures determines that at least one BSR has been triggered and not cancelled, and if a regular BSR has been triggered and a timer (e.g., logicalChannelSR-DelayTimer) is not running, and if there is no UL-SCH resource available for new transmission, UE triggers SR to the target cell if SR configuration including PUCCH resource is provided. In another embodiment, a SR configuration including PUCCH resource for the initial UL transmission for RACH-less cell switch may be provided in the candidate cell configuration. UE may trigger SR to the target cell using the SR configuration if UE has valid TA but no valid UL grant for the target cell.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A user equipment (UE) for facilitating communication in a wireless network, the UE comprising:
a transceiver configured to:
receive, from a source cell, a conditional cell switch configuration including one or more execution conditions for one or more candidate cells, wherein each execution condition of the one or more execution conditions is associated with a conditional cell switch to a corresponding candidate cell; and
a processor operably coupled to the transceiver, the processor configured to:
determine whether the one or more execution conditions are met;
select a candidate cell as a target cell for a conditional cell switch based on a determination that an execution condition of the candidate cell is met; and
determine whether a valid timing advance (TA) and a valid uplink (UL) grant for initial UL transmission to the target cell are available,
wherein the transceiver is further configured to transmit, to the target cell, initial UL transmission using the valid TA and the valid UL grant based on a determination that the valid TA and the valid UL grant are available.

2. The UE of claim 1, wherein the transceiver is further configured to perform random access procedure to the target cell based on a determination that the valid TA is unavailable.

3. The UE of claim 1, wherein the transceiver is further configured to transmit, to the target cell, a scheduling request based on a determination that the valid UL grant is unavailable.

4. The UE of claim 1, wherein the conditional cell switch configuration includes at least one of a TA information or a configured UL grant for the initial UL transmission to the target cell.

5. The UE of claim 4, wherein the processor is configured to determine that the TA information is valid based on a determination that a time condition or a distance condition included in the conditional cell switch configuration is met.

6. The UE of claim 4, wherein the processor is configured to determine that the configured UL grant is valid based on a determination that a time condition included in the conditional cell switch configuration is met.

7. The UE of claim 4, wherein the processor is configured to determine that a pair of the TA information and the configured UL grant is valid based on a determination that a time condition associated with the pair of the TA information and the UL grant is met.

8. The UE of claim 1, wherein:
the conditional cell switch configuration includes one or more configured UL grants for each candidate cell, each configured UL grant of the one or more configured UL grant being associated with a respective one of one or more beams; and
the processor is further configured to:
select a beam among the one or more beams based on the execution condition of the candidate cell; and
determine that a configured UL grant associated with the selected beam is valid.

9. The UE of claim 1, wherein the processor is further configured to:
perform TA estimation for the target cell based on a UE location, satellite ephemeris and common TA information; and
determine that the estimated TA is valid based on the satellite ephemeris and the common TA information provided in the conditional cell switch configuration being valid.

10. A method performed by a user equipment (UE) in a wireless network, the method comprising:
receiving, from a source cell, a conditional cell switch configuration including one or more execution conditions for one or more candidate cells, wherein each execution condition of the one or more execution conditions is associated with a conditional cell switch to a corresponding candidate cell;
determining whether the one or more execution conditions are met;
selecting a candidate cell as a target cell for a conditional cell switch based on a determination that an execution condition of the candidate cell is met;
determining whether a valid timing advance (TA) and a valid uplink (UL) grant for initial UL transmission to the target cell are available; and
transmitting, to the target cell, initial UL transmission using the valid TA and the valid UL grant based on a determination that the valid TA and the valid UL grant are available.

11. The method of claim 10, further comprising performing random access procedure to the target cell based on a determination that the valid TA is unavailable.

12. The method of claim 10, further comprising transmitting, to the target cell, a scheduling request based on a determination that the valid UL grant is unavailable.

13. The method of claim 10, wherein the conditional cell switch configuration includes at least one of a TA information or a configured UL grant for the initial UL transmission to the target cell.

14. The method of claim 13, wherein the determining whether the valid TA and the valid UL grant are available comprises determining that the TA information is valid based on a determination that a time condition or a distance condition included in the conditional cell switch configuration is met.

15. The method of claim 13, wherein the determining whether the valid TA and the valid UL grant are available comprises determining that the configured UL grant is valid based on a determination that a time condition included in the conditional cell switch configuration is met.

16. The method of claim 13, wherein the determining whether the valid TA and the valid UL grant are available comprises determining that a pair of the TA information and the configured UL grant is valid based on a determination that a time condition associated with the pair of the TA information and the UL grant is met.

17. The method of claim 10, wherein the conditional cell switch configuration includes one or more configured UL grants for each candidate cell, each configured UL grant of the one or more configured UL grants being associated with a respective one of one or more beams; and
further comprising:
selecting a beam among the one or more beams based on the execution condition of the candidate cell; and
determining that a configured UL grant associated with the selected beams is valid.

18. The method of claim 10, further comprising:
performing TA estimation for the target cell based on a UE location, satellite ephemeris and common TA information; and
determining that the estimated TA is valid based on the satellite ephemeris and the common TA information provided in the conditional cell switch configuration being valid.

19. A base station (BS) for facilitating communication in a wireless network, the BS comprising:
a transceiver configured to:
receive, from a user equipment (UE), a measurement report; and
a processor operably coupled to the transceiver, the processor configured to:
determine to prepare a conditional cell switch based on the measurement report; and
generate a conditional cell switch configuration including one or more execution conditions for one or more candidate cells, wherein each execution condition of the one or more execution conditions is associated with a conditional cell switch to a corresponding candidate cell,
wherein the transceiver is further configured to transmit the conditional configuration to the UE.

20. The BS of claim 19, wherein the conditional cell switch configuration includes at least one of a timing advance (TA) information or a configured uplink (UL) grant for initial UL transmission to each candidate cell of the one or more candidate cells.
